(19) United States
(12) Patent Application Publication
(10) Pub. No.: US 2026/0364985 A1
(43) Pub. Date: Nov. 19, 2026

(54) TOW HITCH APPARATUS FOR VEHICLE

(71) Applicants: Hyundai Motor Company, Seoul (KR); Kia Corporation, Seoul (KR)

(72) Inventors: Han Seok SONG, Hwaseong-Si (KR); Sung Ki SHIN, Hwaseong-Si (KR); Kyung Tae KWAK, Hwaseong-Si (KR); Chang Un JEON, Hwaseong-Si (KR); Young Jun KIM, Hwaseong-Si (KR); Keun Soo KIM, Hwaseong-Si (KR); Seung Hyun KANG, Hwaseong-Si (KR)

(21) Appl. No.: 19/354,318

(22) Filed: Oct. 9, 2025

(30) Foreign Application Priority Data
May 13, 2025 (KR) 10-2025-0062145

(51) Int. Cl. B60D 1/48; B60D 1/60

(52) U.S. Cl. CPC B60D 1/48; B60D 1/60

(57) ABSTRACT

A tow hitch apparatus includes a first tow hitch member including a tow hitch beam extending in a leftward/rightward direction and having a cross-sectional shape made by cutting the tow hitch beam in a direction intersecting an upward/downward direction, the cross-sectional shape being a curved shape, and first reinforcements coupled to one end and the other end of the tow hitch beam and directed forward and a second tow hitch member including a pair of rear side extension members disposed at a rear side of a vehicle and spaced apart from each other in the leftward/rightward direction of the vehicle, and second reinforcements coupled to rear ends of the rear side extension members, in which the tow hitch beam and the rear side extension member have the same phase based on the upward/downward direction when the first tow hitch member and the second tow hitch member are coupled.

### CROSS-REFERENCE TO RELATED APPLICATION

This application claims priority to and the benefit of Korean Patent Application No. 10-2025-0062145 filed in the Korean Intellectual Property Office on May 13, 2025, the entire contents of which are incorporated herein by reference.

### TECHNICAL FIELD

The present disclosure relates to a tow hitch apparatus for a vehicle.

### BACKGROUND

Tow hitches may be mounted in a port-installed option (PIO) manner or a dealer-installed option (DIO) manner after vehicles are completely produced. For example, a connection portion of the tow hitch may excessively protrude rearward from the vehicle, which may cause a problem in that an aesthetic design appearance deteriorates.

The tow hitch may be coupled to a rear back beam, which is a member related to a rear collision, at a rear side of the vehicle. The inclusion of the rear back beam may disadvantageously add to a weight of the vehicle.

A main member of the tow hitch may be formed to have a curved structure having a height difference when the main member of the tow hitch is formed to extend in a leftward/rightward direction of the vehicle, which causes a problem in that strength and durability deteriorate.

If/when a user manually couples a tow hitch product to the vehicle if/when the tow hitch product has not been subjected to a rear collision evaluation, a rustproof evaluation, and the like, a deterioration in collision stability and a risk of corrosion may increase.

The above information disclosed in this background section is only for enhancement of understanding of the background of the present disclosure and should not be taken as acknowledgement that they correspond to prior art that is already known to a person of ordinary skill in the art.

### SUMMARY

The following summary presents a simplified summary of certain features. The summary is not an extensive overview and is not intended to identify key or critical elements.

Systems, apparatuses/devices, and methods are described for a tow hitch for a vehicle. A tow hitch apparatus may comprise a tow hitch beam extending in a leftward/rightward direction and having a cross-section, in a plane intersecting an upward/downward direction, that is curved; first reinforcements coupled to opposite ends of the tow hitch beam and directed forward; rear side extension frames configured to be disposed at a rear side of a vehicle and spaced apart from each other in the leftward/rightward direction; and second reinforcements coupled to rear ends of the rear side extension frames, wherein the tow hitch beam and the rear side extension frames are configured to overlap in the upward/downward direction based on the tow hitch beam being coupled to the rear side extension frames.

A tow hitch apparatus may also, or alternatively, comprise a tow hitch beam extending in a first direction and having a cross-section, in a plane intersecting a second direction perpendicular to the first direction, that is curved; first reinforcements coupled to opposite ends of the tow hitch beam and directed in a third direction perpendicular to the first direction and the second direction; rear side extension frames spaced apart from each other in the first direction; and second reinforcements coupled to ends of the rear side extension frames towards the first reinforcements, wherein the first reinforcements are coupled to the second reinforcements, and wherein the tow hitch beam and the rear side extension frames overlap in the second direction.

A vehicle may comprise a tow hitch apparatus as disclosed herein. For example, a vehicle may comprise: a chassis and a tow hitch apparatus. the tow hitch apparatus may comprise a tow hitch beam extending in a leftward/rightward direction and having a cross-section, in a plane intersecting an upward/downward direction, that is curved; first reinforcements coupled to opposite ends of the tow hitch beam and directed forward; rear side extension frames configured to be disposed at a rear side of a vehicle and spaced apart from each other in the leftward/rightward direction; and second reinforcements coupled to rear ends of the rear side extension frames, wherein the tow hitch beam and the rear side extension frames are configured to overlap in the upward/downward direction based on the tow hitch beam being coupled to the rear side extension frames. The tow hitch apparatus may also, or alternatively, comprise a tow hitch beam extending in a first direction and having a cross-section, in a plane intersecting a second direction perpendicular to the first direction, that is curved; first reinforcements coupled to opposite ends of the tow hitch beam and directed in a third direction perpendicular to the first direction and the second direction; rear side extension frames spaced apart from each other in the first direction; and second reinforcements coupled to ends of the rear side extension frames towards the first reinforcements, wherein the first reinforcements are coupled to the second reinforcements, and wherein the tow hitch beam and the rear side extension frames overlap in the second direction.

These and other features and advantages are described in greater detail below.

### BRIEF DESCRIPTION OF THE DRAWINGS

FIG. 1 is a perspective view illustrating a tow hitch apparatus for a vehicle according to the present disclosure.

FIG. 2 is an exploded view illustrating a first tow hitch member and a second tow hitch member according to the present disclosure.

FIG. 3 is an exploded perspective view illustrating the second tow hitch member according to the present disclosure.

FIG. 4 is a cross-sectional view taken along line 'A-A' in FIG. 2.

FIG. 5 is an exploded perspective view illustrating the first tow hitch member according to the present disclosure.

FIG. 6 is a cross-sectional view taken along line 'B-B' in FIG. 2.

FIG. 7 is a cross-sectional view taken along line 'C-C' in FIG. 2.

### DETAILED DESCRIPTION

Hereinafter, a tow hitch apparatus according to the present disclosure will be described with reference to the drawings.

Unless otherwise defined, the terms used herein, including technical or scientific terms, may have meanings generally understood by those skilled in the art to which the present disclosure belongs.

The expressions such as "comprise", "may comprise", "include", "may include", "have", "may have", etc. as used herein are intended to mean the presence of a characteristic (e.g., function, operation, component, etc.) and do not exclude the presence of other additional characteristics. That is, these expressions should be understood as open-ended terms that encompass the possibility that other examples are included.

A singular expression used herein may include the meaning of the plural unless otherwise stated in the context, which also applies to the singular expression described in the claims.

Expressions such as "first" or "second" as used herein are used to distinguish one object from another in referring to multiple similar objects, unless otherwise indicated in context, and do not limit the order or importance between them. For example, a plurality of chips according to the present disclosure may be distinguished from each other by referring them as "first chip", "second chip", respectively.

The expression "based on" as used herein is intended to describe one or more factors that influence an act or operation of determining or deciding described in a phrase or sentence including that expression, and this expression does not exclude any additional factors that influence the act or operation of determining or deciding.

When it is described that a component (e.g., a first component) is "connected" or "coupled" to another component (e.g., a second component) as used herein, it may mean that the component is not only directly connected or coupled to another component, but also connected or coupled through yet another component (e.g., a third component).

Depending on the context, the expression "configured to" as used herein may have meanings such as "set to", "with the ability to", "modified to", "made to", "to be able to", etc. This expression is not limited to the meaning of "specially designed in hardware to". For example, a processor configured to perform a specific operation may refer to a generic purpose processor capable of performing the specific operation by executing software, or to a special purpose computer structured through programming to perform the specific operation.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as "A, B, or C", "at least one of A, B, and C", "at least one of A, B, or C", etc. as used herein may mean each listed item or all possible combinations of the listed items. For example, "at least one of A or B" may refer to (1) at least one A; (2) at least one B; or (3) at least one A and at least one B. “One or more of” is synonymous with “at least one of” herein.

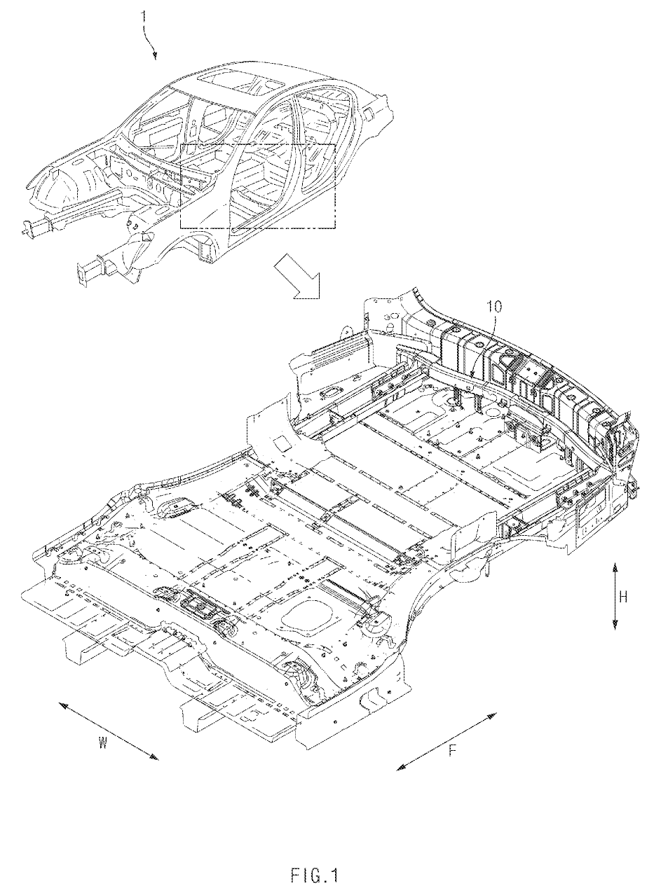

Directions herein, such as “upper”, “lower”, “forward”, “rear”, “leftward”, “rightward”, etc., refer to directions with respect to a vehicle as the tow hitch would be installed. One skilled in the art will understand that the use of directions for illustration/explanation does not imply the disclosed tow hitch need be installed in a vehicle or be in any particular orientation. See, e.g. directions W (leftward/rightward, transverse direction, width direction, first direction herein), F (frontward/rearward; longitudinal direction, length direction, second direction herein), H (up/down; upper/lower; vertical direction, height direction, third direction) in FIG. 1, for example.

### TOW HITCH APPARATUS

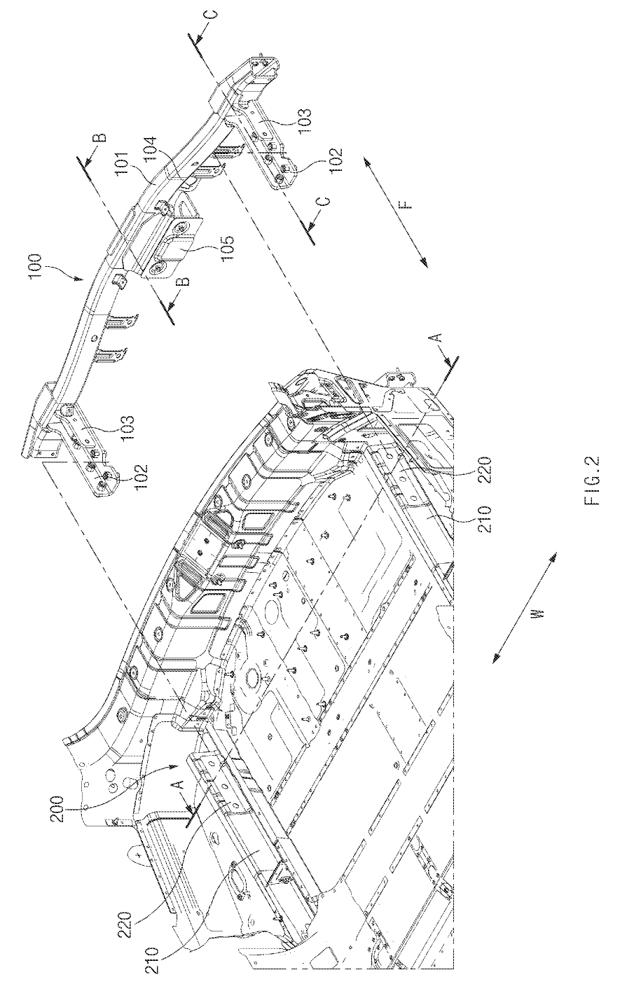

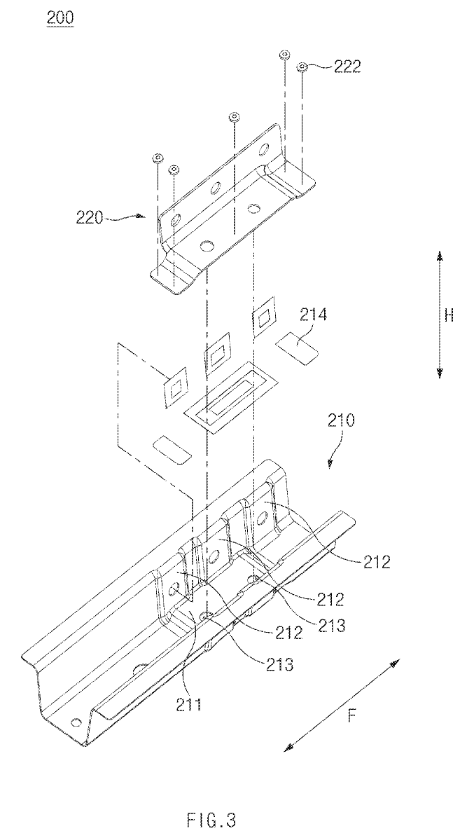

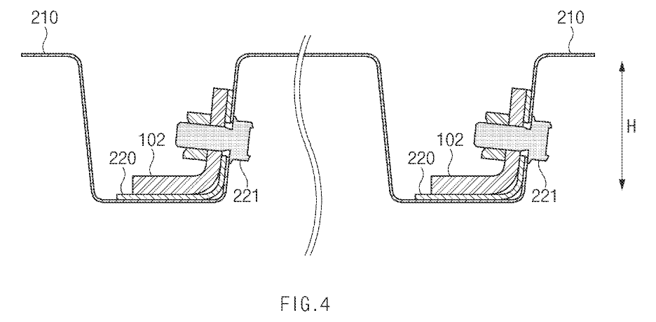

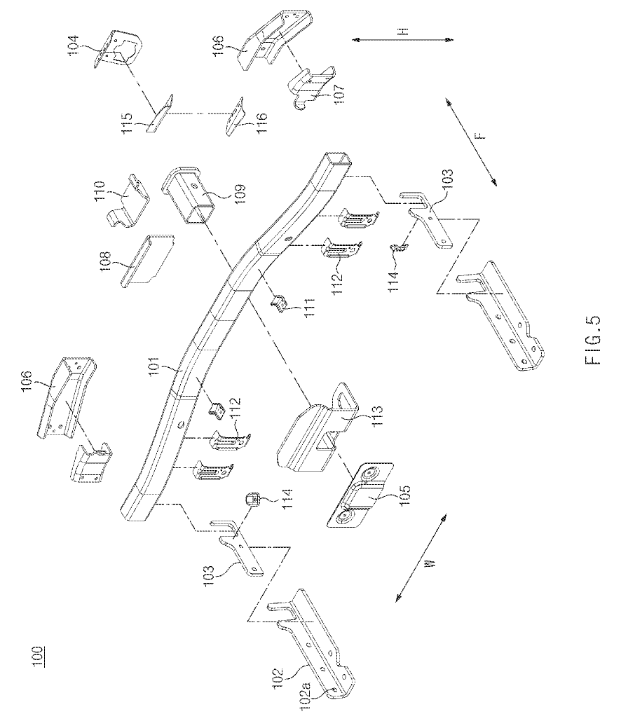

FIG. 1 is a perspective view illustrating a tow hitch apparatus for a vehicle according to the present disclosure, and FIG. 2 is an exploded view illustrating a first tow hitch member and a second tow hitch member according to the present disclosure. FIG. 3 is an exploded perspective view illustrating the second tow hitch member according to the present disclosure. FIG. 4 is a cross-sectional view taken along line 'A-A' in FIG. 2. FIG. 5 is an exploded perspective view illustrating the first tow hitch member according to the present disclosure.

With reference to FIGS. 1-5, a tow hitch apparatus 10 according to the present disclosure may be coupled (e.g., couplable) to a lower side of a rear side of a chassis 1 of a vehicle.

The tow hitch apparatus 10 according to the present disclosure may include a first tow hitch member 100 and a second tow hitch member 200.

The first tow hitch member 100 according to the present disclosure may be inserted and coupled into the second tow hitch member 200 in a sliding manner.

The first tow hitch member 100 according to the present disclosure may include a tow hitch beam 101 and first reinforcements 102.

The tow hitch beam 101 according to the present disclosure may extend in a first direction, such as a leftward/rightward direction W of the vehicle. When/if the tow hitch beam 101 extends in the leftward/rightward direction, the tow hitch beam 101 may be formed straight without a level difference in an upward/downward direction H. The tow hitch beam 101, which is formed straight while extending in the leftward/rightward direction W, may have higher durability and/or strength than a main member of a tow hitch that has a level difference.

A cross-sectional shape of the tow hitch beam 101, which is made by cutting the tow hitch beam 101 in a direction intersecting a horizontal direction of the vehicle (e.g., in a vertical plane roughly in the H and F directions), may comprise a quadrangular hollow cross-section.

The cross-sectional shape of the tow hitch beam 101, which is made by cutting the tow hitch beam 101 in the horizontal direction of the vehicle (e.g., in a horizontal plane in the F and W directions), may comprise a curved shape. The cross-sectional shape of the tow hitch beam 101 made by cutting the tow hitch beam 101 in the horizontal direction may comprise a shape convexly protruding rearward while corresponding to a design of a rear side of the vehicle.

The first reinforcements 102 according to the present disclosure may be coupled to, and protrude forward from, one end and the other end of the tow hitch beam 101 based on the leftward/rightward direction W.

A cross-sectional shape of the first reinforcement 102 according to the present disclosure, made by cutting the first reinforcement 102 in a direction intersecting a forward/rearward direction F of the vehicle, may be an 'L' shape. A rear end of the first reinforcement 102 (rear in the forward/rearward direction F of the vehicle) may be cut concavely upward. For example, the rear end of the first reinforcement 102 may dorm a groove that may be oriented upward when coupled to the tow hitch beam 101. For example, the rear end of the first reinforcement 102 may be formed in an 'F' shape. The rear end of the first reinforcement 102 may be coupled to the tow hitch beam 101.

A plurality of holes 102amay be formed in a front region of the first reinforcement 102. For example, the plurality of holes may be formed to couple the first reinforcement 102 to the second tow hitch member 200 by using bolts or the like.

The first reinforcements 102 according to the present disclosure may be arranged on the basis of the same arranged state if/when the first reinforcements 102 are respectively coupled to a pair of second reinforcements 220. For example, the same arranged state of the first reinforcements 102 refers to a state in which the first reinforcements 102 are disposed in an asymmetric state, instead of a symmetric state, with respect to an imaginary centerline formed at a center of the vehicle based on the forward/rearward direction F if/when the pair of first reinforcements 102 are coupled to the second reinforcements 220.

First fixing members 221 may be coupled to a surface of the 'L' shape of the first reinforcement 102 that corresponds to the upward/downward direction H. For example, the first fixing member 221 may be a bolt.

If/when the pair of first reinforcements 102 are coupled to the second reinforcements 220, the pair of first reinforcements 102 may be arranged in the same arranged state, and the first fixing members 221 may be coupled in the same direction.

The arranged state of the first reinforcements 102 and the coupled state of the first fixing members 221 may allow an operator (e.g., human and/or robotic) to easily assemble the first tow hitch member 100 and the second tow hitch member 200.

The first tow hitch member 100 according to the present disclosure may include all or some of first brackets 103, a second bracket 104, a third bracket 113, fourth brackets 114, a protector 105, a first receiver 109, a second receiver 110, first beams 106, second beams 107, and a third beam 108.

The first bracket 103 according to the present disclosure may be coupled to an upper end surface of the first reinforcement 102 (e.g., by welding). The first bracket 103 may be coupled and/or welded in parallel with a surface of the 'L'-shaped cross-sectional shape of the first reinforcement 102 that corresponds to the upward/downward direction H.

A shape of the first bracket 103 may be a shape having a rear end cut concavely upward. For example, the shape of the rear end of the first bracket 103 may be an 'F' shape. For example, the shape of the rear end of the first bracket 103 may be a shape corresponding to a shape of the rear end of the first reinforcement 102 (e.g., configured to align with a cut end of the first reinforcement 102). A size of the shape of the first bracket 103, which may be concavely cut, may correspond to a size and shape of a lower end surface of a quadrangular cross-section of the tow hitch beam 101. For example, the rear end of the first bracket 103 may be configured to accept/receive the tow hitch beam 101 (the quadrangular cross-section).

The first brackets 103, together with the first reinforcements 102, may be coupled from below to above the tow hitch beam 101 (e.g., the tow hitch beam 101 may be accommodated/accepted/fit in a cut end of the first brackets 103 and cut ends of the first reinforcement 102).

The first brackets 103 may ensure structural consistency and durability of the first tow hitch member 100. For example the first brackets 103 may compensating for a tolerance if/when the first brackets 103 are connected and assembled to the tow hitch beam 101.

The second bracket 104 may be formed in a separate shape and coupled to the tow hitch beam 101. For example, the first tow hitch member 100 according to the present disclosure may be subjected to a surface treatment process for removing an oxide film on a welded portion. A plating layer for ensuring rustproof performance may be formed on the second bracket 104. Therefore, the second bracket 104 may be configured as a separate component and coupled to the tow hitch beam 101, which may prevent a loss of the plating layer caused by the surface treatment process performed on the second bracket 104.

The second bracket 104 may comprise (be manufactured based on) a rustproof material. For example, the second bracket 104 may be manufactured by using any one material among zinc, chromium-nickel, and zinc-nickel (and/or a combination thereof). These materials are provided for illustrative purposes only. The second bracket 104 may be manufactured based on non-disclosed rustproof materials.

The second bracket 104 according to the present disclosure may be coupled to a lower side of the tow hitch beam 101. The second bracket 104 may be coupled to any side of the tow hitch beam 101 in the leftward/rightward direction W based on the second bracket 104 coupled to the lower side of the tow hitch beam 101.

The second bracket 104 according to the present disclosure may be coupled to the tow hitch beam 101 by using a first mounting connector 115 and a second mounting connector 116.

The first mounting connector 115 and the second mounting connector 116 may each be formed in a plate shape including a bent portion. For example, the first mounting connector 115 may have a shape in which a part of an upper region thereof is bent.

A front surface of one bent end of the first mounting connector 115 may be coupled and/or welded to a rear surface of the quadrangular cross-section of the tow hitch beam 101.

A first end of the second mounting connector 116 may be coupled and/or welded to the lower end surface of the quadrangular cross-section of the tow hitch beam 101. A second end of the second mounting connector 116, which excludes the first end (e.g., is opposite to the first end), may be coupled and/or welded to the first mounting connector 115. An order in which the first mounting connector 115 and the second mounting connector 116 are coupled is not limited thereto. After the first mounting connector 115 and the second mounting connector 116 are coupled and/or welded, the first mounting connector 115 and the second mounting connector 116 may be coupled and/or welded to the rear surface and the lower end surface of the tow hitch beam 101.

The first mounting connector 115 and the second mounting connector 116 may be coupled and/or welded to at least one edge of the quadrangular cross-section of the tow hitch beam 101. The first mounting connector 115 and the second mounting connector 116 coupled and/or welded to any one edge of the quadrangular cross-section of the tow hitch beam 101 may be screw-coupled to the second bracket 104.

The second bracket 104 includes at least one hole (not illustrated). When the second bracket 104 is coupled to the first mounting connector 115 and the second mounting connector 116, the second bracket 104 may be coupled so that the hole of the second bracket 104 is formed below the tow hitch beam 101.

For example, a cross-sectional shape of the third bracket 113 taken in a direction intersecting the horizontal direction is an 'L' shape. One surface of the shape of the third bracket 113, which corresponds to the upward/downward direction H, extends upward, and an end of the third bracket 113 is formed to have a portion stepped rearward.

A rearward-stepped region of one surface of the third bracket 113 according to the present disclosure, which corresponds to the upward/downward direction H, may be coupled and/or welded to a front side of a central region of the tow hitch beam 101. According to the coupled state between the tow hitch beam 101 and the third bracket 113, one surface of the 'L' shape of the third bracket 113 formed to correspond to the horizontal direction is kept spaced apart from the lower end surface of the tow hitch beam 101 at a predetermined distance.

The first receiver 109 and the second receiver 110, which will be described below, may be disposed and coupled in the space between the lower end surface of the tow hitch beam 101 and one surface of the lower region of the third bracket 113 that are spaced apart from each other.

A part of a lower end surface of the third bracket 113 according to the present disclosure includes a hole (not illustrated) through which a safety chain may be fastened to a trailer or the like.

In the state in which the first brackets 103 and the tow hitch beam 101 are coupled, the fourth brackets 114 according to the present disclosure are coupled and/or welded to intersection points at which the first brackets 103 and the tow hitch beam 101 are coupled. The fourth bracket 114 may improve the durability between the first bracket 103 and the tow hitch beam 101.

The protector 105 according to the present disclosure may be screw-fastened to a front surface of the 'L' shape of the third bracket 113 formed in the upward/downward direction H.

The protector 105 according to the present disclosure may be made of an aluminum material.

The protector 105 may have a plate shape having a size corresponding to a part or the entirety of a size of the front surface of the third bracket 113.

The protector 105 according to the present disclosure may have a shape in which ends of edges thereof are bent. This is to prevent an injury caused by a sharp end of the protector 105 when the operator or user assembles or disassembles the protector 105 with his/her hand.

A partial region at a center of the protector 105 may protrude forward and be stepped. The protector 105 may prevent damage to a paint film and the occurrence of corrosion caused by chipping while the vehicle travels. For example, debris on a road surface located below the vehicle may fly up while the vehicle travels, and the debris may damage the paint film on the tow hitch apparatus 10. The protector 105 may prevent the paint film on the tow hitch apparatus 10 from being damaged by debris flying up toward a lower side of the vehicle while the vehicle travels.

The first receiver 109 according to the present disclosure is coupled and/or welded to a lower side of the third bracket 113 in a state in which the first receiver 109 is aligned in the forward/rearward direction F. The first receiver 109 may be connected to the trailer by means of a drawbar.

In the tow hitch apparatus 10 according to the present disclosure, a bumper back beam, which is a component in the related art, may be excluded, and a position of the first receiver 109 may be disposed upward in the upward/downward direction H. Because of the change in position of the first receiver 109, the first receiver 109 may be covered by a separate cover provided at a rear lower end of the vehicle. That is, the user uses the separate cover when the tow hitch apparatus 10 is not used, such that the hidden-type tow hitch apparatus 10 may be implemented.

Because the tow hitch apparatus 10 according to the present disclosure excludes the bumper back beam, it is possible to reduce the weight of the vehicle and reduce the manufacturing costs.

The first tow hitch member 100 according to the present disclosure includes clip mountings 111 and bumper mountings 112.

A wire is mounted on the clip mounting 111 according to the present disclosure. The clip mounting 111 is coupled and/or welded to a front surface of the quadrangular cross-section of the tow hitch beam 101. The clip mountings 111 may be disposed at two opposite sides of the third bracket 113 based on a position of the third bracket 113 on the tow hitch beam 101 and coupled and/or welded to the front surface of the tow hitch beam 101.

The bumper mountings 112 according to the present disclosure may be clip-fastened to a bumper of the vehicle. The bumper mountings 112 may be coupled and/or welded to one or more points on the lower end surface of the quadrangular cross-section of the tow hitch beam 101.

The second receiver 110 according to the present disclosure has a shape in which a lower end surface thereof is formed to correspond to the horizontal direction, two opposite ends of the lower end surface based on the leftward/rightward direction W are bent to extend upward, and the two opposite ends, which extend upward, are additionally bent to extend in the leftward/rightward direction W.

The second receiver 110 according to the present disclosure may be positioned, welded, and coupled between the tow hitch beam 101 and the first receiver 109. The second receiver 110 may be disposed to compensate for a level difference in the upward/downward direction H between the first receiver 109 and the tow hitch beam 101.

The first beams 106 and the second beams 107 according to the present disclosure are coupled and/or welded to one end and the other end of the tow hitch beam 101 based on the leftward/rightward direction W.

The first beams 106 and the second beams 107 according to the present disclosure may each have a structure corresponding to a mounting of a towing hook. For example, a cross-sectional shape of each of the first beam 106 and the second beam 107 taken in a direction intersecting the horizontal direction may be a 'C' shape. The first beams 106 and the second beams 107 may be coupled and/or welded in a direction in which the first beams 106 and the second beams 107 face one another, such that the first beams 106 and the second beams 107 may be coupled in a shape corresponding to the cross-section of the tow hitch beam 101.

The third beam 108 according to the present disclosure may be configured in the form of a plate. An upper end edge of the third beam 108 may be bent forward and have a curved shape. On the basis of this shape, the third beam 108 may be coupled and/or welded to the upper end surface and the rear surface of the tow hitch beam 101 and simultaneously coupled and/or welded to the second receiver 110.

The second tow hitch member 200 according to the present disclosure includes rear side extension members 210 and the second reinforcements 220.

The rear side extension members 210 (e.g., rear side extension frame, rear side extension frame rail) according to the present disclosure may be formed at a rear side of the vehicle and/or configured to be installed at a rear side of the vehicle. The rear side extension members 210 may be spaced apart and/or configured to be installed spaced apart from each other in the leftward/rightward direction W of the vehicle.

A cross-sectional shape of the rear side extension member 210 according to the present disclosure perpendicular to the horizontal direction of the vehicle may have an 'H'-shaped cross-section.

The rear side extension member 210 according to the present disclosure may include a first protrusion 211 and second protrusions 212.

The first protrusion 211 according to the present disclosure may have a stepped portion convex upward from an inner lower end surface of a rear end of the rear side extension member 210 (e.g., rear in the forward/rearward direction F of the vehicle).

The first protrusion 211 according to the present disclosure may ensure a gap between the rear side extension member 210 and a component of the chassis 1. The first protrusion may define a space in which a head of a bolt is provided when the bolt is fastened to the rear side extension member 210.

The second protrusions 212 according to the present disclosure may be formed in a rear end region of the rear side extension member 210 (e.g., rear in the forward/rearward direction F of the vehicle). For example, the second protrusions 212 may be formed on two opposite inner wall surfaces of the rear end region of the rear side extension member 210. The second protrusions 212 may each have a stepped portion convex inward from side walls of the 'H'-shaped cross-section of the rear side extension member 210. The second protrusions 212 may increase the occurrence of flows of an electrodeposition liquid during a coating process.

A plurality of coupling holes 213, to which bolts may be coupled, may be formed in the first protrusion 211 and the second protrusions 212 according to the present disclosure.

The second reinforcement 220 according to the present disclosure may be coupled to the rear end of the rear side extension member 210. The second reinforcement 220 may be coupled to a region in which the first protrusion 211 and the second protrusion 212 of the rear side extension member 210 are formed.

For example, black coating may be applied to the rear side extension member 210, the first reinforcement 102, and the second reinforcement 220 according to the present disclosure. However, the configuration in which the black coating is applied is not limited thereto. The black coating may be applied to a part or the entirety of the tow hitch apparatus 10 according to the present disclosure. For example, the black coating refers to one of coating treatment methods that protect components from corrosion and external impact by spraying a rustproof agent or protective agent with a black color.

Oxide films on welded portions of the remaining components of the first tow hitch member 100 and the second tow hitch member 200 of the present disclosure, which exclude the components provided as separate components, may be removed by using a shot blasting process, which may improve paintability.

For example, a gap may be formed by a high load in a portion where the surface of the rear side extension member 210, the surface of the first reinforcement 102, and the surface of the second reinforcement 220 adjoin one another. The gap may be formed if/when a high load is transmitted to the vehicle (e.g., in a state in which the vehicle is connected to a trailer or the like via the tow hitch). The black coating may prevent the occurrence of corrosion in the gap, even though moisture may be introduced into the gap.

The second reinforcement 220 of the present disclosure may be coupled to the rear side extension member 210 by using second fixing members 222. For example, the second fixing member 222 may generate a coupling force between the rear side extension member 210 and the second reinforcement 220 in a self-piercing rivet (SPR) manner.

The second tow hitch member 200 according to the present disclosure may include a bonding member 214. The bonding member 214 may be disposed in the form of a film between the rear side extension member 210 and the second reinforcement 220. The bonding member 214 may also or alternatively be applied in the form of a solution between the rear side extension member 210 and the second reinforcement 220.

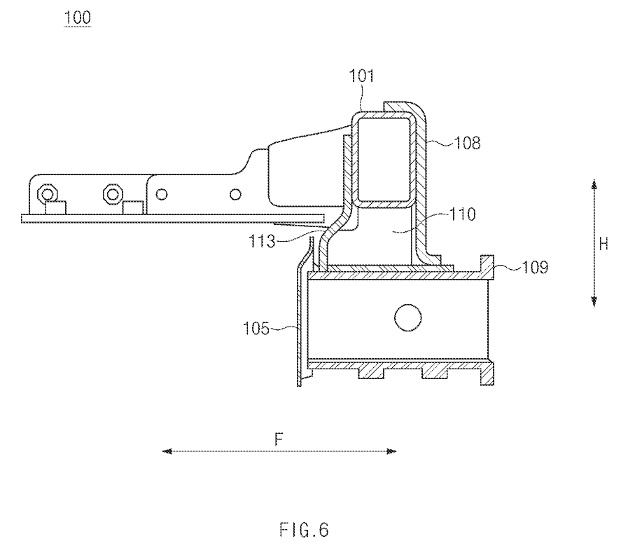

FIG. 6 is a cross-sectional view taken along line 'B-B' in FIG. 2.

With reference to FIGS. 1-6, the second receiver 110 according to the present disclosure may be disposed, coupled and/or welded between the first receiver 109 and the tow hitch beam 101. The second receiver 110 may be coupled to between the first receiver 109 and the tow hitch beam 101 so as to define a structure in which the tow hitch beam 101 is straight in the leftward/rightward direction W, without a level difference in the upward/downward direction H (e.g., without descending and/or extending below. The second receiver 110 may be consistent with a bumper parting line of the vehicle by compensating for a level difference between the tow hitch beam 101 and the first receiver 109.

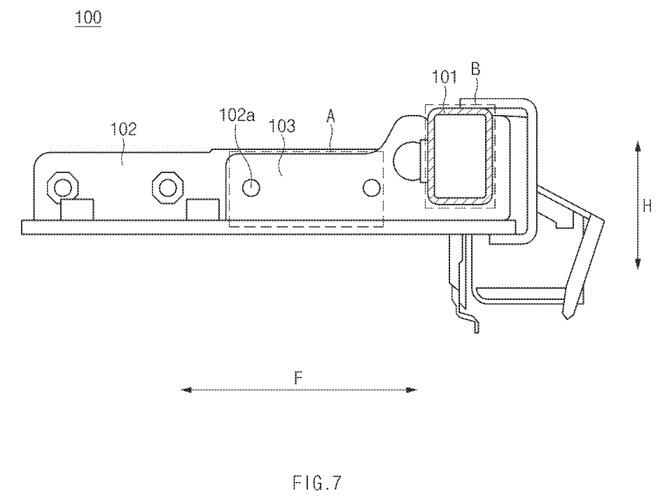

FIG. 7 is a cross-sectional view taken along line 'C-C' in FIG. 2.

With reference to FIGS. 1-7, in the tow hitch apparatus 10 according to the present disclosure, a region A, which corresponds to the rear side extension member 210, and a region B, which corresponds to the tow hitch beam 101, are substantially aligned in the upward/downward direction H if/when the first tow hitch member 100 and the second tow hitch member 200 are coupled. In the upward/downward direction H, the region A, which corresponds to the rear side extension member 210, and the region B, which corresponds to the tow hitch beam 101, may overlap each other. The region A corresponding to the rear side extension member 210 may refer to a region in which the first reinforcement 102 and the first bracket 103 generate a coupling force together with the second reinforcement 220. A height position of the rear side extension member 210 and a height position of the tow hitch beam 101 are consistent with each other (e.g., overlap, are substantially the same) if/when viewed in a lateral direction. Alignment of the rear side extension member 210 and of the tow hitch beam 101 in the height direction may improve a load path of the vehicle and/or increase a durability and/or strength of the tow hitch apparatus 10.

### VEHICLE

A vehicle according to the present disclosure may include the tow hitch apparatus 10.

For example, the tow hitch apparatus 10 may include the first tow hitch member 100. The first tow hitch member may include the tow hitch beam 101 extending in the leftward/rightward direction W of the vehicle. The first tow hitch beam 101 may have the cross-sectional shape in a horizontal (H/F) direction (e.g., made by cutting the tow hitch beam 101 in the direction intersecting/normal to the upward/downward direction H) of a curved shape. The first reinforcements 102 may be coupled to a first end of the tow hitch beam 101 and a second end of the tow hitch beam 101 and directed forward. The tow hitch apparatus 10 may include the second tow hitch member 200, which may include the pair of rear side extension members 210 disposed at the rear side of the vehicle and spaced apart from each other in the leftward/rightward direction W of the vehicle, and the second reinforcements 220 coupled to the rear ends of the rear side extension members 210. The tow hitch beam 101 and the rear side extension member 210 may have the same phase based on the upward/downward direction H when the first tow hitch member 100 and the second tow hitch member 200 are coupled.

The present disclosure has been made in an effort to provide a structure configured to be assembled in advance to a rear side of a vehicle body to improve strength and durability of a tow hitch apparatus and increase productivity of the tow hitch apparatus.

The present disclosure has also been made in an effort to improve rear collision performance and rustproof performance of a vehicle equipped with a tow hitch.

The present disclosure has also been made in an effort to provide a tow hitch apparatus that does not protrude to the outside of a vehicle, thereby improving an aesthetic design appearance.

In order to achieve the above-mentioned objects, one aspect of the present disclosure provides a tow hitch apparatus including: a first tow hitch member including a tow hitch beam extending in a leftward/rightward direction W and having a cross-sectional shape made by cutting the tow hitch beam in a direction intersecting an upward/downward direction H, the cross-sectional shape being a curved shape, and first reinforcements coupled to one end and the other end of the tow hitch beam and directed forward; and a second tow hitch member including a pair of rear side extension members disposed at a rear side of a vehicle and spaced apart from each other in the leftward/rightward direction W of the vehicle, and second reinforcements coupled to rear ends of the rear side extension members, in which the tow hitch beam and the rear side extension member have the same phase based on the upward/downward direction H when the first tow hitch member and the second tow hitch member are coupled.

A cross-sectional shape of the first reinforcement made by cutting the first reinforcement in a direction intersecting a forward/rearward direction F may be an 'L' shape, a rear end of the first reinforcement based on the forward/rearward direction F may be cut concavely upward, and a plurality of holes may be formed in one front region of the first reinforcement.

The first reinforcements may be arranged on the basis of the same arranged state when the first reinforcements are respectively coupled to the pair of second reinforcements, and a first fixing member for generating a fastening force may be coupled in one direction based on the leftward/rightward direction W.

The first tow hitch member may further include: a first bracket welded and coupled to an upper end of a lower end surface of the first reinforcement and having a rear end having a shape cut concavely upward; a second bracket coupled to a lower side of the tow hitch beam; a third bracket having a cross-sectional shape taken in a direction intersecting a horizontal direction, the cross-sectional shape being an 'L' shape, the third bracket having an upper region having a rear surface partially welded and coupled downward to a central region of the tow hitch beam; a first receiver welded and coupled in a state in which the first receiver is aligned on a rear surface of the third bracket in a forward/rearward direction F; a second receiver welded and coupled between the tow hitch beam and the first receiver; and first beams and second beams welded and coupled to one end and the other end of the tow hitch beam based on the leftward/rightward direction W.

The second bracket may be coupled to the tow hitch beam by using: a first mounting connector having one end welded and coupled to a rear surface of a quadrangular cross-section of the tow hitch beam; and a second mounting connector having one end welded and coupled to a lower end surface of the quadrangular cross-section of the tow hitch beam, and the other end excluding one end and welded and coupled to the first mounting connector.

The first tow hitch member may further include: a fourth bracket welded and coupled to an intersection point at which the first bracket and the tow hitch beam are coupled in a state in which the first bracket and the tow hitch beam are coupled; and a protector screw-fastened to a front surface of the third bracket.

The protector may be made of an aluminum material.

The protector may have a shape in which ends of edges thereof are bent.

The rear side extension member may include: a first bead/protrusion having a cross-sectional shape formed to be perpendicular to a horizontal direction and configured to define an 'H'-shaped cross-section, the first bead/protrusion having a stepped portion convex upward from an inner lower end surface of a rear end of the rear side extension member based on a forward/rearward direction F; and second bead/protrusions provided on two opposite inner wall surfaces of a rear end region of the rear side extension member based on the forward/rearward direction F and having stepped portions convex inward.

The second tow hitch member may further include a bonding member disposed or applied between the rear side extension member and the second reinforcement.

The second tow hitch member may further include a second fixing member configured to generate a coupling force between the rear side extension member and the second reinforcement by using a self-piercing rivet (SPR).

Black coating may be applied to the first reinforcement and the second reinforcement.

The first tow hitch member may further include: a clip mounting on which a wire is mounted, the clip mounting being welded and coupled to a front surface of a quadrangular cross-section of the tow hitch beam; and a bumper mounting clip-fastened to a bumper of the vehicle and welded and coupled to an outer lower end surface of the quadrangular cross-section of the tow hitch beam.

The present disclosure may provide the structure configured to be assembled in advance to the rear side of the vehicle body to improve the strength and durability of the tow hitch apparatus and increase the productivity of the tow hitch apparatus.

The present disclosure may improve the rear collision performance and rustproof performance of the vehicle equipped with the tow hitch.

The present disclosure may provide the tow hitch apparatus that does not protrude to the outside of the vehicle, thereby improving the aesthetic design appearance.

The present disclosure has been described with reference to the limited examples and the drawings, but the present disclosure is not limited thereby. The present disclosure may be carried out in various forms by those skilled in the art, to which the present disclosure pertains, within the technical spirit of the present disclosure and the scope equivalent to the appended claims.

What is claimed is:

1. A tow hitch apparatus comprising:
a tow hitch beam extending in a leftward/rightward direction and having a cross-section, in a plane intersecting an upward/downward direction, that is curved;
first reinforcements coupled to opposite ends of the tow hitch beam and directed forward;
rear side extension frames configured to be disposed at a rear side of a vehicle and spaced apart from each other in the leftward/rightward direction; and
second reinforcements coupled to rear ends of the rear side extension frames,
wherein the tow hitch beam and the rear side extension frames are configured to be aligned with each other in the upward/downward direction based on the tow hitch beam being coupled to the rear side extension frames.

2. The tow hitch apparatus of claim 1, wherein:
a cross-section of the first reinforcements in a direction intersecting a forward/rearward direction forms an 'L' shape,
a rear end of the first reinforcements forms a groove concavely upward, and
a plurality of holes are formed in a front region of the first reinforcements.

3. The tow hitch apparatus of claim 1, wherein the first reinforcements are respectively coupled to the second reinforcements via a fastening force in the leftward/rightward direction.

4. The tow hitch apparatus of claim 1, further comprising:
a first bracket, coupled to an upper end surface of the first reinforcements, comprising a rear end that forms a groove concavely upward;
a second bracket coupled to a lower side of the tow hitch beam;
a third bracket comprising a cross-section, in a direction intersecting the leftward/rightward direction, that forms an 'L' shape, wherein the third bracket comprises an upper rear surface partially coupled downward to a central region of the tow hitch beam;
a first receiver aligned on, and coupled to, a rear surface of the third bracket;
a second receiver coupled between the tow hitch beam and the first receiver; and
first beams and second beams coupled to the opposite ends of the tow hitch beam in the leftward/rightward direction.

5. The tow hitch apparatus of claim 4, wherein the second bracket comprises a plating layer.

6. The tow hitch apparatus of claim 4, wherein the second bracket is coupled to the tow hitch beam via:
a first mounting connector comprising an end coupled to a rear surface of a quadrangular cross-section of the tow hitch beam; and
a second mounting connector comprising a first end coupled to a lower end surface of the quadrangular cross-section of the tow hitch beam, and a second end coupled to the first mounting connector.

7. The tow hitch apparatus of claim 4, further comprising:
a fourth bracket coupled to an intersection point at which the first bracket and the tow hitch beam are coupled; and
a protector screw-fastened to a front surface of the third bracket.

8. The tow hitch apparatus of claim 7, wherein the protector comprises an aluminum material.

9. The tow hitch apparatus of claim 7, wherein the protector comprises bent ends.

10. The tow hitch apparatus of claim 1, wherein the rear side extension frames each have an ‘H’-shaped cross-section and comprise:
a first protrusion comprising a stepped portion convex upward from an inner lower end surface of a rear end of the rear side extension frame; and
second protrusions, on two opposite inner wall surfaces of a rear end region of the rear side extension frame, comprising stepped portions convex inward.

11. The tow hitch apparatus of claim 1, further comprising a bonding material between the rear side extension frames and the second reinforcements.

12. The tow hitch apparatus of claim 1, further comprising self-piercing rivets configured to generate a coupling force between each rear side extension frame, of the rear side extension frames, and a corresponding second reinforcement of the second reinforcements.

13. The tow hitch apparatus of claim 1, further comprising a black coating on the first reinforcements and the second reinforcements.

14. The tow hitch apparatus of claim 1, further comprising:
a clip mounting, coupled to a front surface of a quadrangular cross-section of the tow hitch beam, on which a wire is mounted; and
a bumper mounting configured to be clip-fastened to a bumper of the vehicle and coupled to an outer lower end surface of the quadrangular cross-section of the tow hitch beam.

15. A tow hitch apparatus comprising:
a tow hitch beam extending in a first direction and having a cross-section, in a plane intersecting a second direction perpendicular to the first direction, that is curved;
first reinforcements coupled to opposite ends of the tow hitch beam and directed in a third direction perpendicular to the first direction and the second direction;
rear side extension frames spaced apart from each other in the first direction; and
second reinforcements coupled to ends of the rear side extension frames towards the first reinforcements,
wherein the first reinforcements are coupled to the second reinforcements, and wherein the tow hitch beam and the rear side extension frames be aligned with each other in the second direction.

16. The tow hitch apparatus of claim 15, wherein the rear side extension frames and the second reinforcements form grooves configured to accommodate the opposite ends of the tow hitch beam.

17. The tow hitch apparatus of claim 15, wherein the rear side extension frames each comprise:
an inner lower surface and side walls on opposite sides of the inner lower surface;
a first protrusion upward from the inner lower surface of a portion of the rear side extension frame towards the tow hitch beam; and
second protrusions inward from inner surfaces of the side walls.

18. The tow hitch apparatus of claim 15, further comprising a bonding material between the rear side extension frames and the second reinforcements.

19. The tow hitch apparatus of claim 15, wherein the rear side extension frames are coupled to the second reinforcements by self-piercing rivets.

20. A vehicle comprising:
a chassis; and
a tow hitch apparatus comprising:
a tow hitch beam extending in a leftward/rightward direction and having a cross-section, in a plane intersecting an upward/downward direction, that is curved;
first reinforcements coupled to opposite ends of the tow hitch beam and directed forward;
a pair of rear side extension frames disposed at a rear side of the chassis of the vehicle and spaced apart from each other in the leftward/rightward direction; and
second reinforcements coupled to rear ends of the rear side extension frames,
wherein the tow hitch beam and the rear side extension frames are configured to overlap in the upward/downward direction based on the tow hitch beam being coupled to the rear side extension frames.
